(19) United States
(12) Patent Application Publication
(10) Pub. No.: US 2024/0348384 A1
(43) Pub. Date: Oct. 17, 2024

(54) METHOD AND DEVICE FOR TRANSMITTING SIGNAL IN WIRELESS COMMUNICATION SYSTEM

(71) Applicant: LG Electronics Inc., Seoul (KR)

(72) Inventors: Hyunmin KIM, Seoul (KR); Sunam KIM, Seoul (KR); Young Dae KIM, Seoul (KR)

(21) Appl. No.: 18/685,810

(22) PCT Filed: Aug. 27, 2021
(86) PCT No.: PCT/KR2021/011544

§ 371 Date: Feb. 22, 2024

(51) Int. Cl. H04L 5/00

(52) U.S. Cl. CPC H04L 5/0035; H04L 5/0051

(57) ABSTRACT

Disclosed herein are a method for operating a uplink CoMP and a device using the same. As an example of the present disclosure, a method for operating a user equipment in a wireless communication system may include transmitting, by the user equipment, user equipment capability information to a primary-transmission reception point (TRP), receiving, by the user equipment, a radio resource control (RRC) reconfiguration request message from the primary-TRP, and transmitting, by the user equipment, data to the primary-TRP and a secondary-TRP. Herein, the user equipment capability information may include beam information of the user equipment, and the beam information of the user equipment may include information regarding whether or not the user equipment uses at least one of a phase array antenna (PAA) and multi-beams. Resources of the primary-TRP and the secondary-TRP may be allocated based on the beam information of the user equipment.

### TECHNICAL FIELD

The present disclosure relates to a wireless communication system, and more particularly, to a device and method for uplink coordinated multi-point (CoMP).

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

The present disclosure may provide a device and method for uplink coordinated multi-point (CoMP) in a wireless communication system.

The technical objects to be achieved in the present disclosure are not limited to the above-mentioned technical objects, and other technical objects that are not mentioned may be considered by those skilled in the art through the embodiments described below.

### Technical Solution

As an example, a method for operating a user equipment in a wireless communication system may include transmitting, by the user equipment, user equipment capability information to a primary-transmission reception point (TRP), receiving, by the user equipment, a radio resource control (RRC) reconfiguration request message from the primary-TRP, and transmitting, by the user equipment, data to the primary-TRP and a secondary-TRP. Herein, the user equipment capability information may include beam information of the user equipment, and the beam information of the user equipment may include information regarding whether or not the user equipment uses at least one of a phase array antenna (PAA) and multi-beams. Resources of the primary-TRP and the secondary-TRP may be allocated based on the beam information of the user equipment.

As an example, of the present disclosure, a method for operating a primary-transmission reception point (TRP) in a wireless communication system may include receiving user equipment capability information from a user equipment, transmitting a radio resource control (RRC) reconfiguration request message to the user equipment, and receiving data from the user equipment. Herein, the user equipment capability information may include beam information of the user equipment, and the beam information of the user equipment may include information regarding whether or not the user equipment uses at least one of a phase array antenna (PAA) and multi-beams. A resource of the primary-TRP may be allocated based on the beam information of the user equipment.

As an example, a user equipment in a wireless communication system may include a transceiver and a processor coupled with the transceiver. The processor may control the transceiver to transmit user equipment capability information to a primary-transmission reception point (TRP). The processor may control the transceiver to receive a radio resource control (RRC) reconfiguration request message from the primary-TRP. The processor may control the transceiver to transmit data to the primary-TRP and the secondary-TRP. Herein, the user equipment capability information may include beam information of the user equipment, and the beam information of the user equipment may include information regarding whether or not the user equipment uses at least one of a phase array antenna (PAA) and multi-beams. Resources of the primary-TRP and the secondary-TRP may be allocated based on the beam information of the user equipment.

As an example, a communication device may include at least one processor and at least one computer memory that is coupled with the at least one processor and stores an instruction that instructs operations when executed by the at least one processor. The processor may control the communication device to transmit user equipment capability information to a. primary-transmission reception point (TRP). The processor may control the communication device to receive a radio resource control (RRC) reconfiguration request message from the primary-TRP. The processor may control the communication device to transmit data to the primary-TRP and the secondary-TRP. Herein, the user equipment capability information may include beam information of the communication device, and the beam information of the communication device may include information regarding whether or not a user equipment uses at least one of a phase array antenna (PAA) and multi-beams. Resources of the primary-TRP and the secondary-TRP may be allocated based on the beam information of the communication device.

As an example of the present disclosure, a non-transitory computer-readable medium storing at least one instruction may include the at least one instruction that is executable by a processor. The at least one instruction may instruct the computer-readable medium to transmit user equipment capability information to a primary-transmission reception point (TRP). The at least one instruction may instruct the computer-readable medium to receive a radio resource control (RRC) reconfiguration request message from the primary-TRP. The at least one instruction may instruct the computer-readable medium to transmit data to the primary-TRP and the secondary-TRP. Herein, the user equipment capability information may include beam information of the computer-readable medium. The beam information of the computer-readable medium may include information regarding whether or not the computer-readable medium uses at least one of a phase array antenna (PAA) and multi-beams. Resources of the primary-TRP and the secondary-TRP may be allocated based on the beam information of the computer-readable medium.

As an example, a transmission reception point (TRP) in a wireless communication system may include a transceiver and a processor coupled with the transceiver. The processor may be configured to receive user equipment capability information from a user equipment. The processor may be configured to transmit a radio resource control (RRC) reconfiguration request message to the user equipment. The processor may be configured to receive data from the user equipment. Herein, the user equipment capability information may include beam information of the user equipment, and the beam information of the user equipment may include information regarding whether or not the user equipment uses at least one of a phase array antenna (PAA) and multi-beams. A resource of the TRP may be allocated based on the beam information of the user equipment.

The above-described aspects of the present disclosure are merely some of the preferred embodiments of the present disclosure, and various embodiments reflecting the technical features of the present disclosure may he derived and understood by those of ordinary skill in the art based on the following detailed description of the disclosure.

### Advantageous Effects

As is apparent from the above description, the embodiments of the present disclosure have the following effects.

According to the present disclosure, a user equipment may obtain a diversity gain even when a channel environment is not good.

According to the present disclosure, a transmission reception point (TRP) resource may he efficiently allocated.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a band-held device applicable to the present disclosure.

FIG. 5 is a view showing an example of a car or an autonomous driving car applicable to the present disclosure.

FIG. 6 is a diagram illustrating an example of an AI device applied to the present disclosure.

FIG. 7 is a diagram illustrating a method of processing a transmitted signal applied to the present disclosure.

FIG. 8 and FIG. 9 are views showing beams according to various conditions.

FIG. 10 is a view showing one example of CoMP applicable to the present disclosure.

FIG. 11 is a view showing one example of CoMP procedure applicable to the present disclosure.

FIG. 12 is a view showing a cell edge applicable to the present disclosure.

FIG. 13 is a view showing one example of CoMP procedure applicable to the present disclosure.

FIG. 14 is a view showing one example of CoMP applicable to the present disclosure.

FIG. 15 is a view showing one example of coverage extension applicable to the present disclosure.

FIG. 16 is a view showing one example of a procedure of operating a user equipment applicable to the present disclosure.

FIG. 17 is a view showing one example of a procedure of operating a primary-TRP applicable to the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data. transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a-fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may he explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail. LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

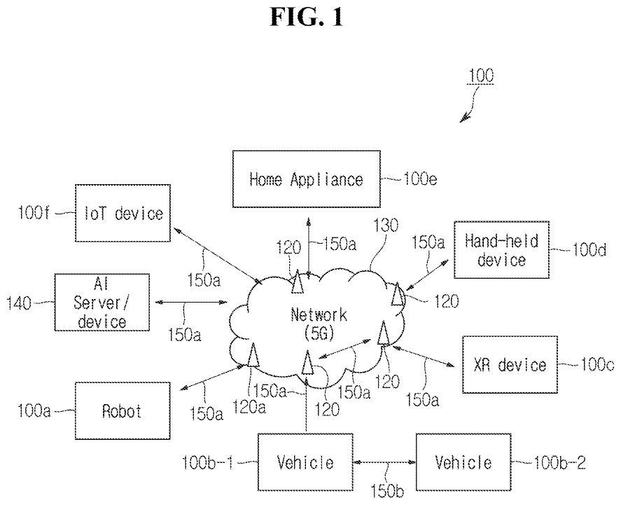

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology 5G NR or LTE) and may be referred to as a communication/wireless/5G device. Without being limited thereto, the wireless device may include a robot 100a, vehicles 100b-1 and 100b-2, an extended reality (XR) device 100c, a band-held device 100d, a home appliance 100e, an Internet of Thing (IoT) device 100f, and an artificial intelligence (AI) device server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial-vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The band-held device 100d may include a smartphone, a smart pad, a wearable device (e.g., a smart watch or smart glasses), a computer (e.g., a laptop), etc. The home appliance 1000 may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

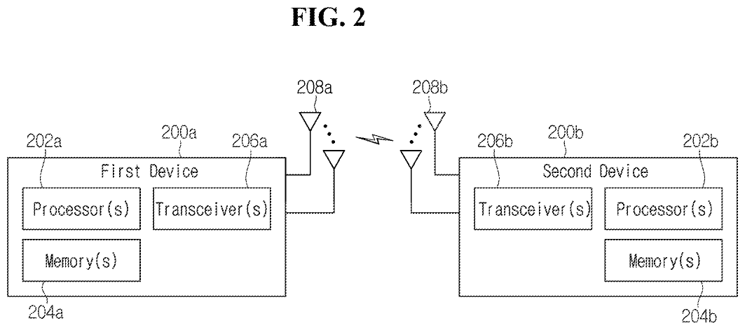

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

As an example, a first wireless device may be a user equipment including a transceiver and a processor coupled with the transceiver. The processor may control the transceiver to transmit user equipment capability information to a primary-transmission reception point (TRP). The processor may control the transceiver to receive a radio resource control (RRC) reconfiguration request message from the primary-TRP. The processor may control the transceiver to transmit data to the primary-TRP and the secondary-TRP. Herein, the user equipment capability information may include beam information of the user equipment, and the beam information of the user equipment may include information regarding whether or not the user equipment uses at least one of a phase array antenna (PAA) and multi-beams. Resources of the primary-TRP and the secondary-TRP may be allocated based on the beam information of the user equipment.

As another example, a first wireless device may include at least one processor and at least one computer memory that is coupled with the at least one processor and stores an instruction that instructs operations when executed by the at least one processor. The processor may control the communication device to transmit user equipment capability information to a primary-transmission reception point (TRP). The processor may control the communication device to receive a radio resource control (RRC) reconfiguration request message from the primary-TRP. The processor may control the communication device to transmit data to the primary-TRP and the secondary-TRP. Herein, the user equipment capability information may include beam information of the communication device, and the beam information of the communication device may include information regarding whether or not a user equipment uses at least one of a phase array antenna (PAA) and multi-beams. Resources of the primary-TRP and the secondary-TRP may be allocated based on the beam information of the communication device.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modern/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals anchor methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods anchor operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

As an example, a non-transitory computer-readable medium storing at least one instruction may include the at least one instruction that is executable by a processor. The at least one instruction may instruct the computer-readable medium to transmit user equipment capability information to a primary transmission reception point (TRP). The at least one instruction may instruct the computer-readable medium to receive a radio resource control (RRC) reconfiguration request message from the primary-TRP. The at least one instruction may instruct the computer-readable medium to transmit data to the primary-TRP and the secondary-TRP. Herein, the user equipment capability information may include beam information of the computer-readable medium, and the beam information of the computer-readable medium may include information regarding whether or not the computer-readable medium uses at least one of a phase array antenna (PAA) and multi-beams. Resources of the primary-TRP and the secondary-TRP may be allocated based on the beam information of the computer-readable medium.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or fliers.

### Structure of Wireless Device Applicable to the Present Disclosure

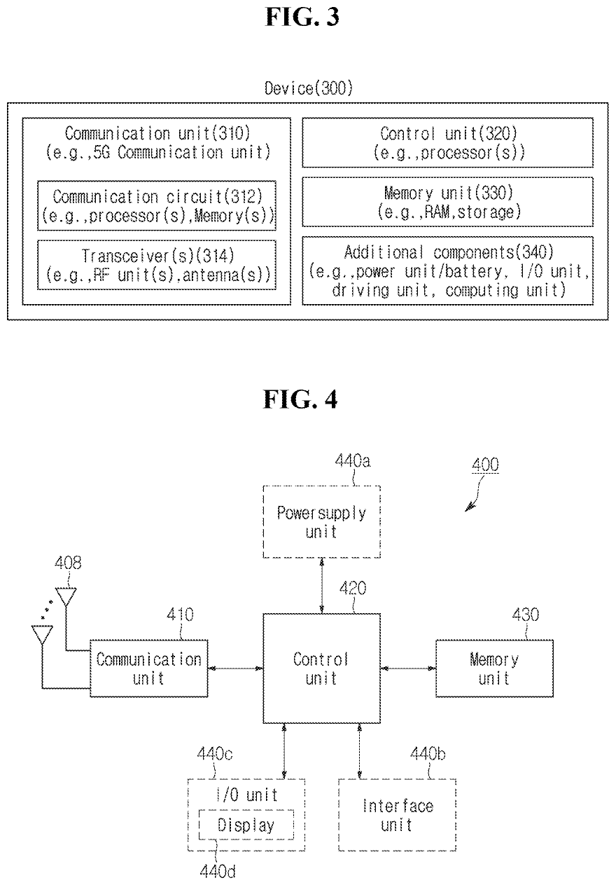

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the band-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fin-tech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 is a view showing an example of a band-held device applicable to the present disclosure.

FIG. 4 shows a band-held device applicable to the present disclosure. The band-held device may include a smartphone, a smart pad, a wearable device (e.g., a smart watch or smart glasses), and a band-held computer (e.g., a laptop, etc.). The band-held device may be referred to as a mobile station (MS), a user terminal (UT), a mobile subscriber station (MSS), a subscriber station (SS), an advanced mobile station (AMS) or a wireless terminal (WT).

Referring to FIG. 4, the band-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the band-held device 400 to perform various operations. The control unit 420 may include an application processor (AP). The memory unit 430 may store data/parameters/program/code/instructions necessary to drive the band-held device 400. In addition, the memory unit 430 may store input/output data/information, etc. The power supply unit 440a may supply power to the band-held device 400 and include a wired/wireless charging circuit, a battery, etc. The interface unit 44 Oh may support connection between the band-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

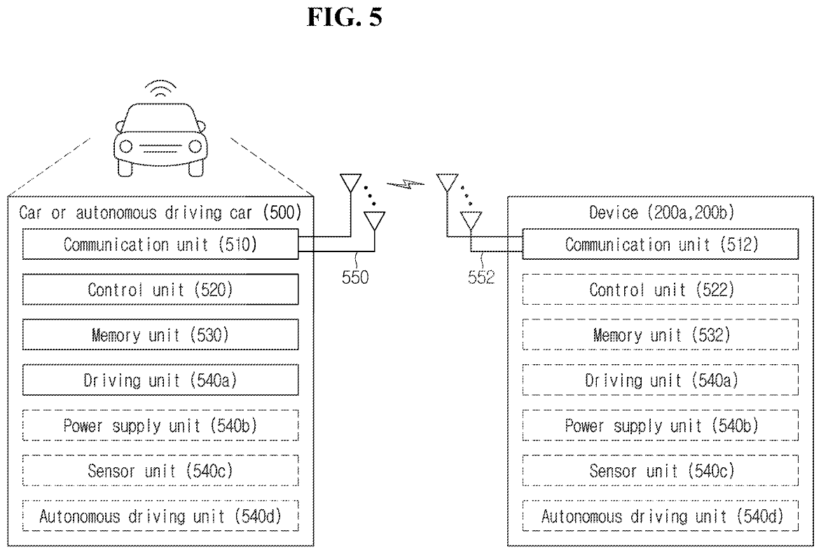

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

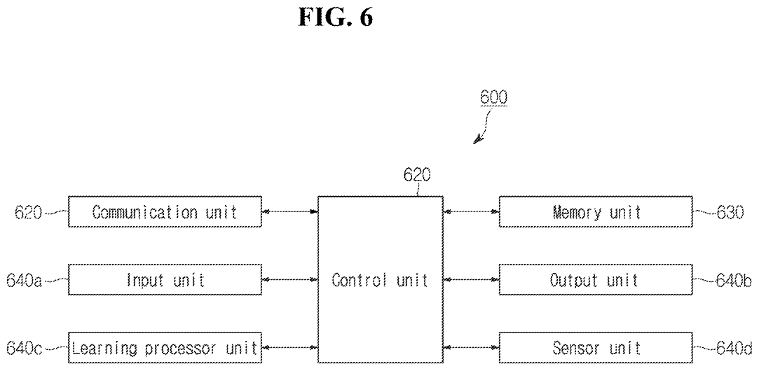

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 62 (a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the teaming model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition,-the output value of the learning processor unit 640c may be transmitted to an external device through the communication unit 610 and/or stored in the memory unit 630.

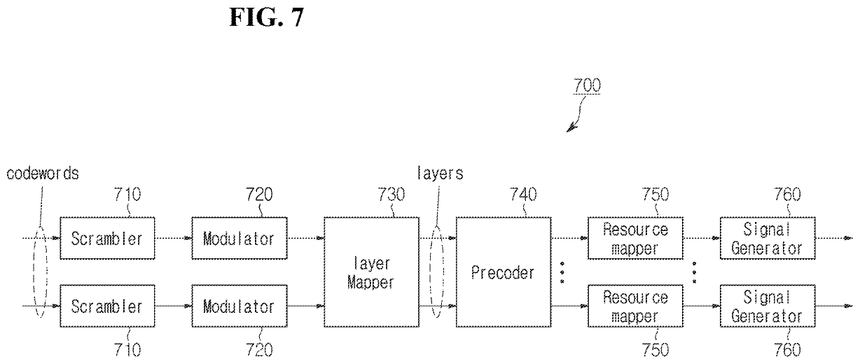

FIG. 7 is a diagram illustrating a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), in-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a. plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### Terahertz (THz) Communication

THz communication may be applied in a 6G system. As an example, a data transfer rate may be improved by increasing a bandwidth. This may be implemented by using sub-THz communication in a broad bandwidth and applying an advanced massive MIMO technique.

THz wave, also known as submillimeter radiation, usually shows a frequency band between 0.1 THz and 10 THz with a wavelength range of 0.03 mm to 3 mm. The band range of 100 GHz to 300 GHz (Sub THz band) is considered as a main portion of a THz band for cellular communication. If the sub THz band is added to an mmWave band, 6G cellular communication capacity is increased. In the THz band thus defined, the range of 300 GHz to 3 THz belongs to a far-infrared radiation (IR) frequency band. The 300 GHz to 3 Thz band is a part of the optical band but is a boundary of the optical band and immediately follows the RE band. Accordingly, this 300 GHz to 3 THz band is similar to RE

As main features, THz communication includes (i) a bandwidth broadly available for supporting a very high data transfer rate and (ii) high path loss that occurs in a high frequency (a high directivity antenna is indispensable). A narrow beam width generated in a high directivity antenna reduces interference. A small wavelength of a THz signal enables a far larger number of antenna elements to be integrated into a device and a BS operating in this band. Thus, it is possible to use an advanced adaptive array technique capable of overcoming a range constraint.

### THz Wireless Communication

THz wireless communication uses a THz wave with a frequency of about 0.1 to 10 Thz (1 THz=1012 Hz) and may mean THz band wireless communication using a very high carrier frequency of 100 GHz or above. THz waves are located between the radio frequency (RF)/millimeter (mm) and the infrared radiation (IR) band, penetrate nonmetal/nonpolarized materials better than visual light/IR, and have a shorter wavelength than RF/mm waves so that they may have high straightness and enable beam focusing.

### Specific Embodiments of the Present Disclosure

The future Internet of things (FIoT) should satisfy low power, low complexity, high reliability, and low latency. In addition, a low-priced IoT device should satisfy high reliability and low latency in a massive environment. FIoT should necessarily consider a feature of beam. A beam has a directional feature. Accordingly, a beam has a feature of resistance to interference However, when a device uses a beam, a signal to noise ratio (SNR) may worsen according to blockage and an environment.

Studies are underway about uplink multi-beam in a multi transmission reception point (TRP) environment. Especially, a channel mapping operation of channel state information-reference signal (CSI-RS) is a main subject of such studies. The uplink (UL) coordinated multi-point (CoMP) is an added technology in LTE. UL CoMP has the effect of interference mitigation. Various procedures of UL CoMP may be useful for low latency and high throughput. As an example, in case a user equipment (UE) is located in an edge of a beam, the UE may transmit data not to a primary node but to a neighboring secondary node with a better channel component than the primary node or receive data from the secondary node. In this way, the UE may be expected to increase throughput. In addition, signaling overhead delay may be reduced. In addition, the UE may obtain a diversity gain. As for UL CoMP, a UE may perform an operation of searching for a secondary cell, while being connected to a primary cell. In case a UE has N beams using a multi panel, the UE's beam operation for a secondary cell and an operation of periodically measuring the secondary cell may be added. A UL CoMP operation based on multi-beams may omit the above-described operations, thereby reducing complexity.

True time delay (TTD)-based multi-beams may all be separated into as many beams as a bandwidth part (BWP)/N (number of multi-beams). Accordingly, a UE using TTD-based multi-beams may transmit and receive data to and from a plurality of UEs or TRPs at the same time. However, because the UE using the TTD-based multi-beams can use nothing but a BWP corresponding to a number of beams, throughput may be decreased. To overcome this disadvantage, a technology available in a domain with a low data rate required such as IoT may be defined.

The present disclosure proposes a hybrid TTD and a phased array antenna (PAA) that uses a minimum number of panels, uses a feature of a beam as it is, and perform simultaneous transmission and reception. In addition, the present disclosure proposes an uplink CoMP based on the hybrid TTD and PAA.

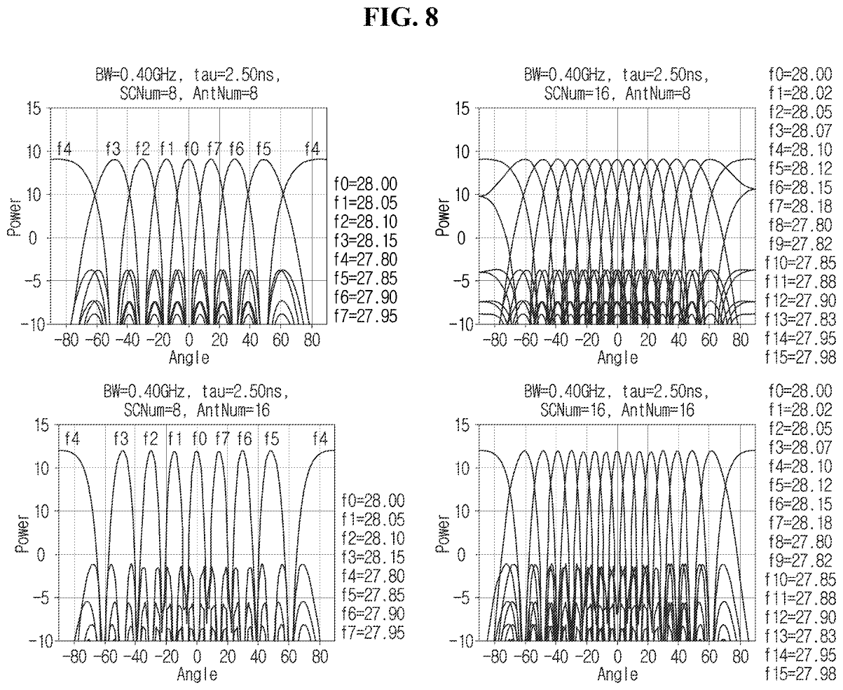

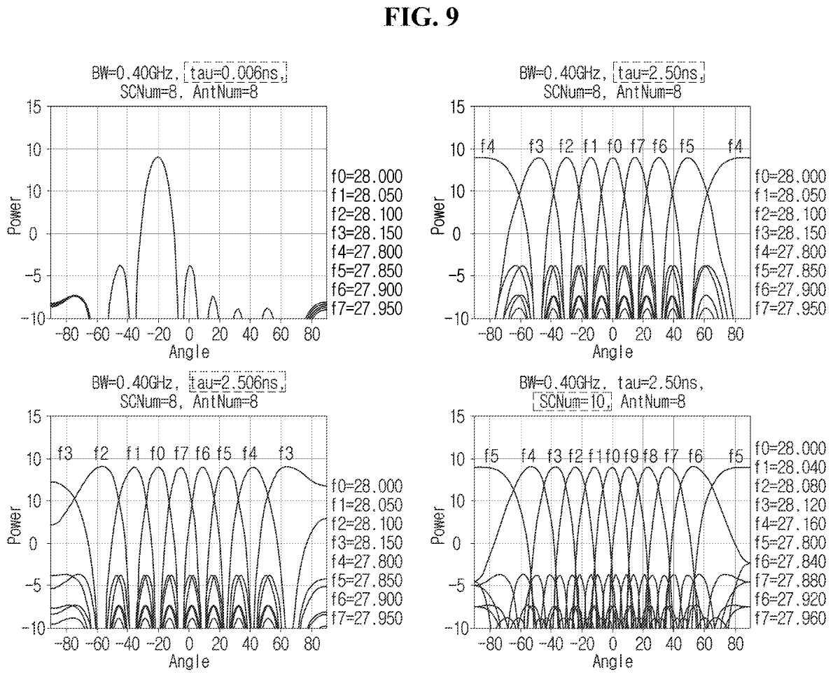

FIG. 8 and FIG. 9 are views showing beams according to various conditions. TTD-based multi-beams are a technology using a feature that an angle of a beam changes according to a length of a time delay. TTD-based multi-beams are a technique of forming multi-beams with a maximum value for different angles at each frequency by generating a time delay difference between array antennas. A beam shape may be expressed by Equation 1 below Specifically, in case a time delay is applied to a uniformly spaced linear array, a beamforming gain or an array gain for a frequency fₘ may be expressed by Equation 1 below

$$G ( θ , {f}_{m} ) = \frac{1}{{N}_{R}} {\vert \frac{sin [ \frac{{N}_{R} π}{2} ( 2 {f}_{m} {Δ}_{T} + ( {f}_{m} / {f}_{c} ) sin ( θ ) ) ]}{sin [ \frac{π}{2} ( 2 {f}_{m} {Δ}_{T} + ( {f}_{m} / {f}_{c} ) sin ( θ ) ) ]} \vert}^{2} \qquad [ Equation 1 ]$$

Fc may denote a center frequency of a frequency. Fm may denote a frequency corresponding to a subcarrier index m. Δτ may denote a time delay difference between array antenna elements. That is, from a first array antenna element, a second array antenna element may have a delay of Δτ. From the first array antenna element, a third antenna element may have a delay of Δτ*2. FIG. 8 and FIG. 9 are plotted diagrams based on Equation 1, showing how beams are formed for frequency and angle according to various conditions. Herein, various conditions may include a number of subcarriers, a number of antennas, and a delay value.

A user equipment may use as many resources as BWP/N for each beam. Because frequency resources available for each beam are limited, the user equipment may also use a phased antenna array (PAA) technique for broadband data communication. For example, a. user equipment may use a multi-panel TTD that applies a same time-delay value to each panel. In addition, the user equipment may form multiple layers by applying different phase shift values at the same time. The user equipment may apply an antenna weight vector (AWV) to each array element n for k-layer in a PAA as below. K-layer may correspond to a k-th panel. K denotes a total number of layers. The rotation of a beam may be expressed by Equation 2 below. In an multi-layer extension, as many resources as BW allocated per layer * beam may be used in one beam.

$${[ {w}_{PAA , k} ]}_{n} = exp [ j 2 π ( n - 1 ) k / K ] \qquad [ Equation 2 ]$$

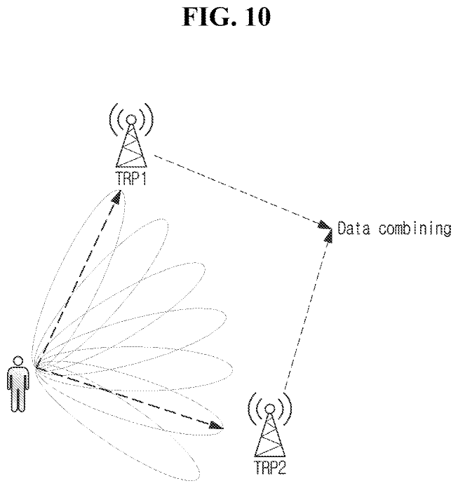

FIG. 10 is a view showing one example of CoMP applicable to the present disclosure. Generally, a CoMP may be configured in centralized coordination and/or decentralized coordination. In the centralized coordination, a single central unit controls a plurality of base stations. The central unit and the base stations may be connected through fiber. In the decentralized coordination, a control unit may be connected with a base station through an S1 interface, and base stations may be connected with each other through an X2 interface. The decentralized coordination is a structure that enables control data to be transmitted and received even between base stations.

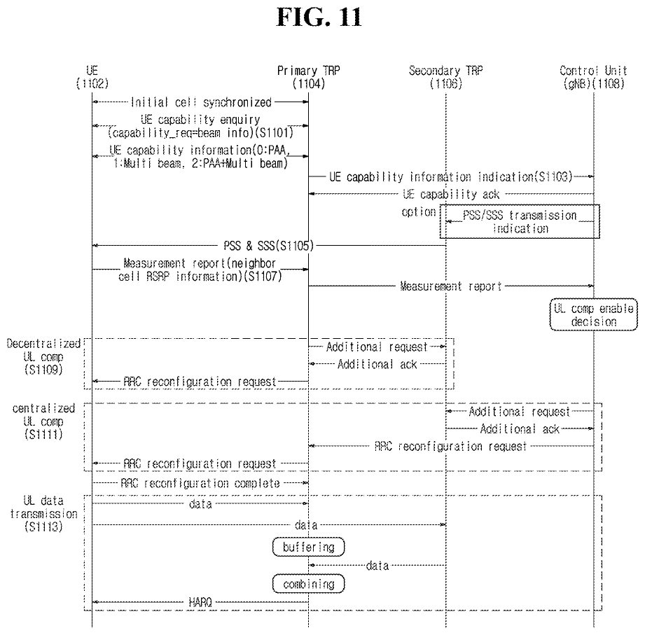

FIG. 11 is a view showing one example of CoMP procedure applicable to the present disclosure. A user equipment (UE) 1102 may perform initial synchronization with a primary cell 1104. Cell and TRP may be used interchangeably. A control unit 1108 may include a base station and a CPU. In case the control unit 1108 is a gNB, a primary-transmission reception point (TRP) 1104 and a secondary-TRP 1106 may be radio frequency (RE) units that are controlled by the control unit. TRP may mean a node performing transmission and reception and is not limited to the above-described embodiment.

The primary-TRP 1104 may transmit a UE capability enquiry message to the UE 1102 (S1101). The primary-TRP may check, through the message, whether the UE uses only a PAA, only multi-beams, or both a PAA and multi-beams. That is, the primary-TRP may receive a beam type of the UE through the UE capability enquiry message. As an example, the UE capability enquiry message may include a capability_req parameter. The capability_req parameter may include a beam info flag.

The UE may receive the UE capability enquiry message from the primary-TRP and transmit UE capability information to the primary-TRP. The UE capability information may include beam information of the UE. That is, the UE capability information may include information regarding whether the UE use only a PAA, only multi-beams, or both the PAA and the multi-beams. In addition, such contents may be delivered through a bit map. For example, the bit map may be represented by 0=PAA only, 1=Multi beam only, and 2=PAA+Multi beam.

The primary-TRP receiving the UE capability information delivers the information to the control unit. That is, the primary-TRP may transmit a UE capability information indication message to the control unit (S1103). The control unit may include a base station and a controller. The base station may include a gNB and is not limited to the above-described embodiment. The control unit may know the UE capability information through the UE capability information indication message. The control unit may receive the UE capability information and transmit ACK to the primary-TRP.

The UE may receive a synchronization signal from a secondary-TRP (S1105). Herein, the synchronization signal may include a primary synchronization signal (PSS) and a secondary synchronization signal (SSS). The UE may periodically try to receive the synchronization signal to know the presence of a neighboring TRP, when multi-beams are enabled. The UE does not have to adjust a frame boundary to the secondary-TRP. Specifically, it is sufficient for the UE to recognize the presence of the second-TRP, and the UE does not have to perform an operation of adjusting the frame boundary.

As an example, when a control unit knows UE capability information, the control unit may order a neighboring TRP to transmit a synchronization message toward a UE. The secondary-TRP, which receives a synchronization message transmission instruction, may transmit a synchronization signal to the UE.

As another example, a TRP may autonomously transmit a synchronization message to a UE periodically. That is, even if the TRP does not receive a synchronization message transmission instruction from a control unit, the TRP may periodically transmit a. synchronization signal to the UE.

When the UE recognizes the presence of the neighboring TRP through measurement, the UE may deliver a measurement report message to the primary cell (S1107). This message may include a measurement result value of a secondary cell. In addition, the measurement report message may include a RSRP measurement value or a secondary cell ID. The primary-TRP, which receives the measurement report message, may deliver the result to the control unit. The control unit may know that there are the UE with an enabled specific multi-beam and enabling UL CoMP for the UE is possible. The control unit may make a decision to enable a CoMP based on the measurement report message.

FIG. 12 is a view is a view showing a cell edge applicable to the present disclosure. A user equipment may periodically perform measurement. The user equipment may periodically report a measurement result value to a primary-TRP. Accordingly, a control unit may determine an approximate location of a beam of the user equipment. The beam may have a feature of a sharp shape. In consideration of the shape of the beam, the user equipment may be located in a cell edge as shown in FIG. 12.

Hereinafter, a decentralized UL CoMP procedure will be described (S1109). In case a user equipment is located in a cell edge, a primary-TRP may inform a control unit of a measurement value and additionally whether or not a UL CoMP is available. As an example, a message such as a UL CoMP request message may be defined. Specifically, the primary-TRP may transmit a UL CoMP request message to the control unit. If the UL CoMP is available, the control unit may inform the primary-TRP of information on a TRP where the UL CoMP is possible, through a UL CoMP confirm message. Based on the UL CoMP confirm message, the primary-TRP may deliver an additional request message to the TRP that will perform the UL CoMP, through an X2 interface. The additional request message may include information on the primary-TRP and UL resource information.

As an example, the primary-TRP may transmit the additional request message to a secondary-TRP. The primary-TRP may receive ACK on the additional request message from the secondary-TRP. The primary-TRP, which receives ACK, may know RRC parameter information including a resource of the secondary-TRP and timing. The primary-TRP, which receives ACK, may deliver a radio resource control (RRC) reconfiguration message to the user equipment.

The user equipment may update information on the primary-TRP and the secondary-TRP based on the RRC reconfiguration message. The user equipment may perform a RRC reconfiguration procedure. The user equipment may update whether or not a secondary cell is present and a necessary configuration for UL CoMP.

The user equipment may data to the primary-TRP and the secondary-TRP through allocated resource information. The secondary-TRP may transmit the received data to the primary-TRP. The primary-TRP may combine the data received from the user equipment and the data received from the secondary-TRP. The primary-TRP may transmit HARQ feedback on the received data to the user equipment.

Hereinafter, a centralized UL CoMP will be described (S1111). A control unit may transmit an additional request message to a secondary-TRP. The secondary-TRP may receive the additional request message and transmit ACK on the additional request message to the control unit. The control unit, which receives ACK, may know RRC parameter information including a resource of the secondary-TRP and timing.

The control unit may transmit a RRC reconfiguration request message to a primary-TRP. The primary-TRP may transmit the RRC reconfiguration request message to a user equipment. The user equipment may update information on the primary-TRP and the secondary-TRP based on the RRC reconfiguration message. The user equipment may perform a RRC reconfiguration procedure. The user equipment may update whether or not a secondary cell is present and a necessary configuration for UL CoMP.

The user equipment may transmit data to the primary-TRP and the secondary-TRP respectively through allocated resource information. The secondary-TRP may transmit the received data to the primary-TRP. The primary-TRP may combine the data received from the user equipment and the data received from the secondary-TRP. The primary-TRP may transmit HARQ feedback on the received data to the user equipment. The decentralized UL CoMP procedure of step S1111 and the centralized UL CoMP procedure of step S1113 may be performed independently of each other or be performed together.

Hereinafter will be described effects according to the present disclosure. An environment of a channel of every beam or an environment of a channel where a user equipment has a beam alignment with TRPs may worsen. A user equipment may obtain a maximum SNR by simultaneously transmitting same data with a plurality of beams to a same symbol and resource block, instead of transmitting data with a single beam. Such an operation is channel-robust. In addition, such an operation may increase diversity gain. This effect may be obtained when a user equipment uses multi-beams based UL CoMP. As an example, a control unit may know channel environment information of every TRP that is connected with a user equipment. Accordingly, a control unit may predict that a max SNR can be derived through a UL CoMP. In addition, a control unit may perform UL CoMP scheduling to obtain such an effect.

In case a beam of a user equipment is only for a PAA, if a user equipment has a poor channel state with a primary TRP or has a blocked channel state therewith, an initial synchronization procedure may be performed first to find a new TRP. Such an operation may take a long time. When the user equipment enables multi-beams based UL CoMP, a secondary-TRP may be additionally connected in the blocked environment, and data may be transmitted to the secondary-TRP. Accordingly, latency may be reduced.

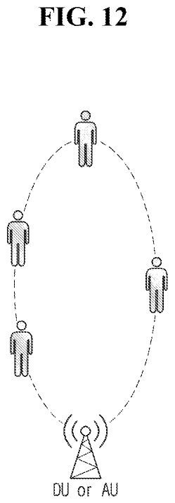

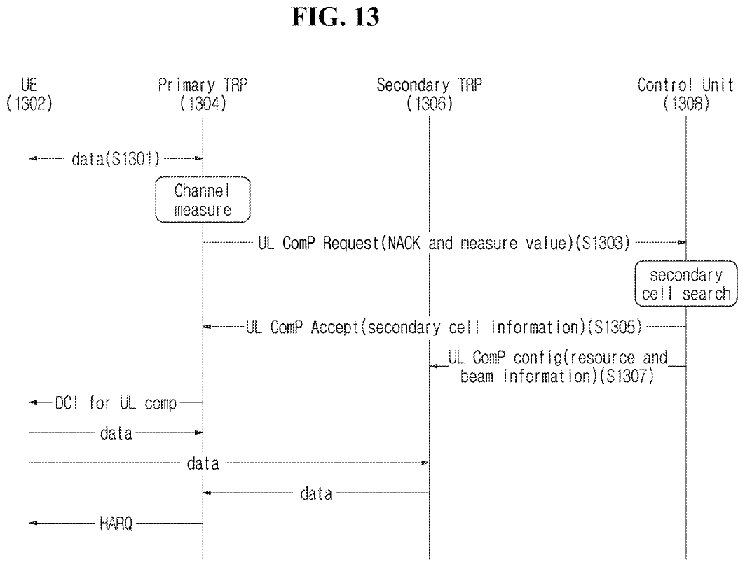

FIG. 13 is a view showing one example of CoMP procedure applicable to the present disclosure. Specifically, FIG. 13 is a view showing one example of a TTD-based multi-beam UL CoMP operation procedure. According to this procedure, a user equipment 1302 may obtain diversity gain even when a channel environment is not good. Interference may occur between the user equipment 1302 and a primary-TRP 1304 because of a cell edge or any other element. In case a channel environment is not good, reliability of UL data of a user equipment may be reduced. In addition, throughput of a user equipment may be reduced, and latency may increase. The following UL CoMP may solve this problem. It is a characteristic of FIoT that a TRP is very likely to be fixed. A control unit may know the locations and muncher of TRPs around a user equipment. Accordingly, the control unit may prepare some of resources to be used by neighboring TRPs for UL CoMP and additionally select a beam. A detailed operation is as follows.

A user equipment may transmit and receive data to and from a primary-TRP (S1301). While the user equipment transmits and receives data, the user equipment may move to a cell edge. In this case, a channel quality may worsen. In addition, the channel quality may worsen for another reason and is not limited to above-described embodiment.

When the channel quality is not good, the primary-TRP may perform RSRP measurement through a demodulation reference signal (DMRS) and a sounding reference signal (SRS). The primary-TRP may perform RSRP measurement by using a reference signal and is not limited to the above-described embodiment. The primary-TRP may know a user equipment state through such measurement. In case the primary-TRP transmits data, the primary-TRP may know a state of the user equipment through a measurement report message.

Based on the user equipment state, the primary-TRP may determine whether or not to perform the UL CoMP operation. When the primary-TRP determines that the channel quality is not good, the primary-TRP may transmit a UL CoMP request message to the control unit in order to receive a resource for UL CoMP from the control-unit (S1303). The UL CoMP request message may include a measurement result value or information on a resource use status. The UL CoMP request message may include NACK.

The control unit may find a secondary-TRP for UL CoMP and transmit primary-TRP information and secondary-TRP information to the primary-TRP and the secondary-TRP respectively. As an example, the control unit may transmit a UL CoMP accept message to the primary-TRP (S1305), and the UL CoMP accept message may include secondary cell information. In addition, the control unit may transmit a UL CoMP config message to the secondary-TRP (S1307), and the UL CoMP config message may include primary cell information. In addition, the UL CoMP config message may include resource and beam information.

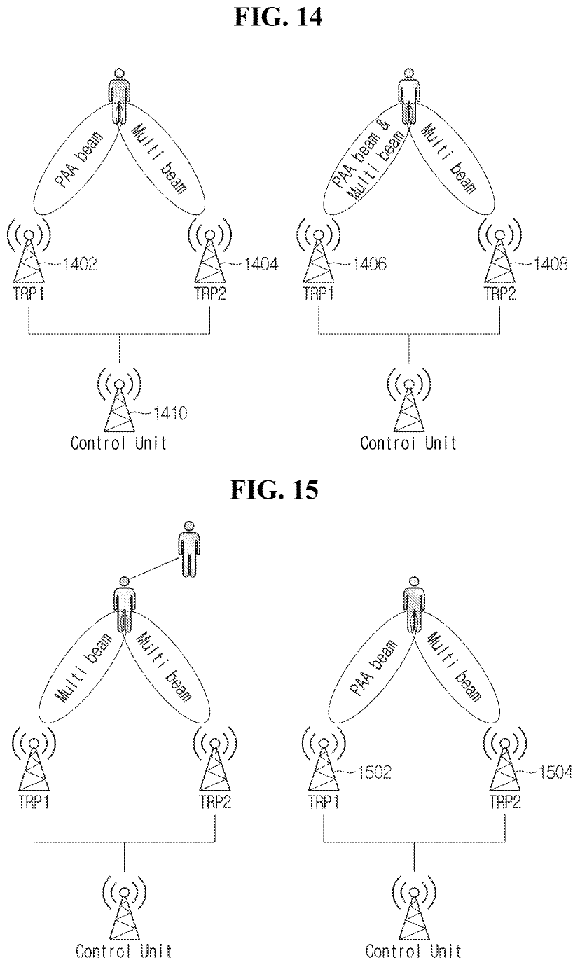

FIG. 14 is a view showing one example of CoMP applicable to the present disclosure. Specifically, FIG. 14 is a view showing one example of a TTD-based multi-beam UL CoMP. A user equipment may use multi-beams and a PAA simultaneously based on multi-panel. In the case of TTD-based multi-beams, a user equipment should use a resource by orthogonally dividing it into as many as a multiple of the number of beams. Accordingly, throughput may be reduced. In case a user equipment uses multi-panels, this disadvantage may be improved. In case multi-panels are enabled, a user equipment may operate as shown in FIG. 14.

Referring to the left side of FIG. 14, a TRP1 1402 may use PAA beam, and a TRP2 1404 may use only multi-beam. Referring to the right side of FIG. 14, a TRP1 1406 may receive multi-beam and PAA beam at the same time, and a TRP2 1408 may use only multi-beam. A control unit may determine a beam. The control unit may allocate a resource for a total BWP which is an aggregate of a BWP of a TRP1 and a BWP of a TRP2. Because of a characteristic of multi-beam, no interference may occur when a BWP of a beam connected to a primary-TRP and a secondary-TRP is orthogonal to a BWP of another beam.

Accordingly, in case a user equipment transmits data based on a PAA, a control unit may allocate a resource to be orthogonal to a resource of a neighboring beam. In addition, in case a user equipment transmits multi-beams and a PAA beam in a same direction, a control unit may use the above resource orthogonal to the multi-beams and the neighboring beam.

FIG. 15 is a view showing one example of coverage extension applicable to the present disclosure. As compared with TTD-based multi-beams, a PAA may use a wider BWP. Accordingly, in case a user equipment is getting farther away from any one TRP while performing a UL CoMP operation, the user equipment becomes incapable of using multi-beam. In this case, a control unit may enable the user equipment to user a PAA. In addition, the control unit may additionally reduce a code rate and increase a length of an allocated resource block (RB), thereby consequently increasing total power. In addition, the control unit may increase a coverage length and keep performing a UL CoMP service. Referring to the right side of FIG. 15, in case a user equipment is getting farther away from a TRP1 1502 while performing a UL CoMP operation, the user equipment may become incapable of using multi-beams. Accordingly, a control unit may enable the user equipment connected to the TRP1 1502 to use a PAA.

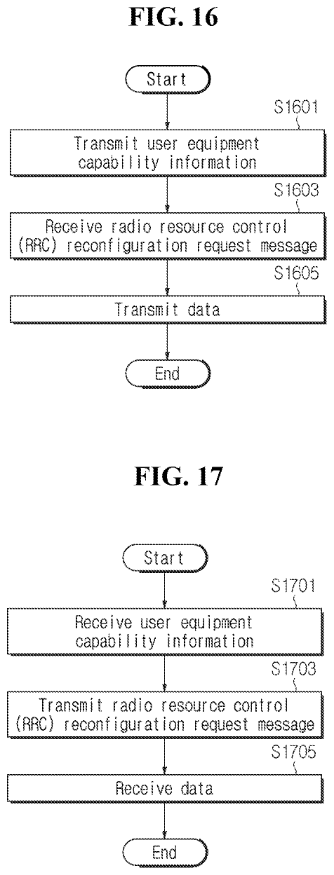

FIG. 16 is a view showing one example of a procedure of operating a user equipment applicable to the present disclosure. At step S1601, a user equipment may transmit user equipment capability information. Hereinafter, it will be described in detail.

As an example, a primary-TRP may transmit a user equipment (UE) capability enquiry message to the UE. Through the message, the primary-TRP may check whether the UE uses only PAA, only multi-beams, or both PAA and multi-beams. That is, the primary-TRP may receive a beam type of the UE through the UE capability enquiry message. The UE capability enquiry message may include a capability_req parameter. The capability_req may include a beam info flag.

The UE may receive the UE capability enquiry message from the primary-TRP and transmit UE capability information to the primary-TRP. The UE capability information may include beam information of the UE. As an example, the UE capability information may include information regarding whether the UE use only PAA, only multi-beams, or both PAA and multi-beams. That is, the UE capability information may include beam information of the UE, and the beam information of the UE may include information regarding whether or not the UE uses at least any one of phased array antenna (PAA) and multi-beams. In addition, as described below, resources of the primary-TRP and a secondary-TRP may be allocated based on the beam information of the UE. In addition, contents may be delivered through a bit map. For example, the bit map may be represented by 0=PAA only, 1=Multi beam only, and 2=PAA+Multi beam.

The primary-TRP receiving the UE capability information may deliver the information to the control unit. That is, the primary-TRP may transmit a UE capability information indication message to the control unit. The control unit may include a base station and a controller. The base station may include a gNB and is not limited to the above-described embodiment. The control unit may know the UE capability information through the UE capability information indication message. The control unit may receive the UE capability information and transmit ACK to the primary-TRP.

The UE may receive a synchronization signal from the secondary-TRP. Herein, the synchronization signal may include a primary synchronization signal (PSS) and a secondary synchronization signal (SSS). The UE may periodically try to receive the synchronization signal to know the presence of a neighboring TRP, when multi-beams are enabled. The UE does not have to adjust a frame boundary to the secondary-TRP. Specifically, it is sufficient for the UE to recognize the presence of the second-TRP, and the UE does not have to perform an operation of adjusting the frame boundary.

As an example, when the control unit knows the UE capability information, the control unit may order a neighboring TRP to transmit a synchronization message toward the UE. The secondary-TRP, which receives the synchronization message transmission instruction, may transmit the synchronization signal to the UE.

As another example, a TRP may autonomously transmit the synchronization message to the UE periodically. That is, even if the TRP does not receive the synchronization message transmission instruction from the control unit, the TRP may periodically transmit the synchronization signal to the UE.

When the UE recognizes the presence of the neighboring TRP through measurement, the UE may deliver a measurement report message to the primary cell. This message may include a measurement result value of a secondary cell. In addition, the measurement report message may include a RSRP measurement value or a secondary cell ID. The primary-TRP, which receives the measurement report message, may deliver the result to the control unit. The control unit may know that there are the UE with enabled specific multi-beams and enabling UL CoMP for the UE is possible. The control unit may make a decision to enable a CoMP based on the measurement report message.

At step S1603, a RRC reconfiguration request message may be received.

As an example, the UE may receive the RRC reconfiguration request message based on a decentralized UL CoMP. In case the UE is located in a cell edge, the primary-TRP may inform the control unit of a measurement value and additionally whether or not a UL CoMP is available. As an example, a message such as a UL CoMP request message may be defined. Specifically, the primary-TRP may transmit a UL CoMP request message to the control unit. If the UL CoMP is available, the control unit may inform the primary-TRP of information on a TRP where the UL CoMP is possible, through a UL CoMP confirm message. Based on the UL CoMP confirm message, the primary-TRP may deliver an additional request message to the TRP that will perform the UL CoMP, through an X2 interface. The additional request message may include information on the primary-TRP and UL resource information.

As an example, the primary-TRP may transmit the additional request message to the secondary-TRP. The primary-TRP may receive ACK on the additional request message from the secondary-TRP. The primary-TRP, which receives ACK, may know RRC parameter information including a resource of the secondary-TRP and timing. The primary-TRP, which receives ACK, may deliver a radio resource control (RRC) reconfiguration message to the user equipment. The UE may receive the RRC reconfiguration message from the primary-TRP.

The UE may update information on the primary-TRP and the secondary-TRP based on the RRC reconfiguration message. The UE may perform a RRC reconfiguration procedure. The UE may update whether or not a secondary cell is present and a necessary configuration for UL CoMP. The UE may transmit a RRC reconfiguration complete message to the primary-TRP.

As another example, the UE may receive the RRC reconfiguration request message based on a centralized UL CoMP. A control unit may transmit an additional request message to a secondary-TRP. The secondary-TRP may receive the additional request message and transmit ACK on the additional request message to the control unit. The control unit, which receives ACK, may know RRC parameter information including a resource of the secondary-TRP and timing.

The control unit may transmit the RRC reconfiguration request message to a primary-TRP. The primary-TRP may transmit the RRC reconfiguration request message to the UE. The UE may receive the RRC reconfiguration request message from the primary-TRP. The UE may update information on the primary-TRP and the secondary-TRP based on the RRC reconfiguration message. The UE may perform a RRC reconfiguration procedure. The UE may update whether or not a secondary cell is present and a necessary configuration for UL CoMP.

At step S1605, the UE may transmit data. The UE may transmit data to the primary-TRP and the secondary-TRP respectively through information on an allocated resource. The secondary-TRP may transmit the received data to the primary-TRP. The primary-TRP may combine the data received from the UE and the data received from the secondary-TRP. The primary-TRP may transmit HARQ feedback on the received data to the UE.

Meanwhile, hereinafter, a procedure for obtaining diversity gain by a user equipment (UE) when a channel quality is not good. It is assumed that the UE transmits and receives data to and from a primary-TRP. While the UE transmits and receives data, the UE may move to a cell edge. In this case, a channel quality may worsen. In addition, the channel quality may worsen for another reason and is not limited to above-described embodiment.

When the channel quality is not good, the primary-TRP may perform RSRP measurement through a demodulation reference signal (DMRS) and a sounding reference signal (SRS). The primary-TRP may perform RSRP measurement by using a reference signal and is not limited to the above-described embodiment. The primary-TRP may know a UE state through such measurement. In case the primary-TRP transmits data, the primary-TRP may know a state of the UE through a measurement report message.

Based on the UE state, the primary-TRP may determine whether or not to perform the UL CoMP operation. When the primary-TRP determines that the channel quality is not good, the primary-TRP may transmit a UL CoMP request message to the control unit in order to receive a resource for UL CoMP from the control unit. The UL CoMP request message may include a measurement result value or information on a resource use status. The UL CoMP request message may include NACK.

The control unit may find a secondary-TRP for UL CoMP and transmit primary-TRP information and secondary-TRP information to the primary-TRP and the secondary-TRP respectively. As an example, the control unit may transmit a UL CoMP accept message to the primary-TRP, and the UL CoMP accept message may include secondary cell information. In addition, the control unit may transmit a UL CoMP config message to the secondary-TRP, and the UL CoMP config message may include primary cell information. In addition, the UL CoMP config message may include resource and beam information.

The primary-TRP may transmit DCI on the UL CoMP to the UE. As an example, as described above, the DCI may be DCI based on a measurement value through channel estimation of the primary-TRP. The subsequent data transmission procedure is the same as step S1605.

FIG. 17 is a view showing one example of a procedure of operating a primary-TRP applicable to the present disclosure.

At step S1701, a primary-TRP may receive user equipment (UE) capability information.

As an example, the primary-TRP may transmit a UE capability enquiry message to a UE. Through the message, the primary-TRP may check whether the UE uses only PAA, only multi-beams, or both PAA and multi-beams. A parameter of the message is the same as described above.

The UE may receive the UE capability enquiry message from the primary-TRP and transmit UE capability information to the primary-TRP Beam information included in the UE capability information is the same as described above.

The primary-TRP receiving the UE capability information may deliver the information to the control unit. The control unit may know the UE capability information through the UE capability information indication message. The control unit may receive the UE capability information and transmit ACK to the primary-TRP.

When the UE recognizes the presence of the neighboring TRP through measurement, the UE may deliver a measurement report message to the primary cell. This message may include a measurement result value of a secondary cell. In addition, the measurement report message may include a RSRP measurement value or a secondary cell ID. The primary-TRP, which receives the measurement report message, may deliver the result to the control unit. The control unit may know that there are the UE with enabled specific multi-beams and enabling UL CoMP for the UE is possible. The control unit may make a decision to enable a CoMP based on the measurement report message.

At step S1703, the primary-TRP may transmit a RRC reconfiguration request message. As an example, the primary-TRP may transmit the RRC reconfiguration request message to the UE based on the above-described step S1109 or step S1111.

At step S1705, the primary-TRP may receive data. The primary-TRP may receive data from the UE and the secondary-TRP. The primary-TRP may combine the data received from the UE and the data received from the secondary-TRP. The primary-TRP may transmit HARQ feedback on the received data to the UE.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a user equipment (UE) in a wireless communication system, the method comprising:
receiving, from a primary-transmission reception point (TRP), UE capability enquiry message;
transmitting, to the primary-TRP, UE capability information;
receiving, from the primary-TRP, a radio resource control (RRC) reconfiguration message;
transmitting, to the primary-TRP, a RRC reconfiguration complete message; and
transmitting data to the primary-TRP and a secondary-TRP,
wherein the UE capability information includes beam information related to whether the UE uses at least one of a phase array antenna (PAA) and multi-beams, and
wherein at least one resource of the primary-TRP and the secondary-TRP is allocated based on the beam information.

2. The method of claim 1, wherein resource information of the primary-TRP and the secondary-TRP is updated based on the RRC reconfiguration message.

3. The method of claim 1, further comprising:
receiving, from the primary-TRP, downlink control information (DCI) for an uplink coordinated multi-point (CoMP) is received,
wherein the DCI is based on a measurement value based on channel estimation of the primary-TRP.

4. The method of claim 1, further comprising:
receiving a synchronization signal from the secondary-TRP, and
transmitting, to the primary-TRP, a received signal received power (RSRP) value, which is measured based on the synchronization signal.

5. The method of claim 4, wherein the synchronization signal includes a primary synchronization signal (PSS) and a secondary synchronization signal (SSS).

6. The method of claim 5, wherein the synchronization signal is transmitted by the secondary-TRP based on a synchronization signal transmission instruction, and is transmitted toward the UE.

7. The method of claim 5, wherein the synchronization signal is periodically transmitted by the secondary-TRP.

8. A method performed by a primary-transmission reception point (TRP) in a wireless communication system, the method comprising:
transmitting, from a primary-transmission reception point (TRP), user equipment (UE) capability enquiry message;
receiving, from a UE, UE capability information;
transmitting, to the UE, a radio resource control (RRC) reconfiguration message;
receiving, to the primary-TRP, a RRC reconfiguration complete message; and
receiving data from the UE,
wherein the UE capability information includes beam information related to whether the UE uses at least one of a phase array antenna (PAA) and multi-beams, and
wherein at least one resource of the primary-TRP and a secondary-TRP is allocated based on the beam information.

9. The method of claim 8,
wherein the UE updates resource information of the primary-TRP and the secondary-TRP based on the RRC reconfiguration message.

10. The method of claim 8, further comprising:
transmitting, to the UE, downlink control information (DCI) for an uplink coordinated multi-point (CoMP),
wherein the DCI is based on a measurement value based on channel estimation of the primary-TRP.

11. The method of claim 8, further comprising:
receiving, from the UE, wherein a received signal received power (RSRP) value, which is measured based on a synchronization signal, and
wherein the synchronization signal is received by the UE from the secondary-TRP.

12. The method of claim 11, wherein the synchronization signal includes a primary synchronization signal (PSS) and a secondary synchronization signal (SSS).

13. The method of claim 12, wherein the synchronization signal is transmitted by the secondary-TRP based on a synchronization signal transmission instruction, and is transmitted toward the UE.

14. The method of claim 12, wherein the synchronization signal is periodically transmitted by the secondary-TRP.

15. A user equipment (UE) operating in a wireless communication system, the UE comprising:
a transceiver; and
a processor coupled to the transceiver,
wherein the processor is configured to:
receive, from a primary-transmission reception point (TRP), UE capability enquiry message;
transmit, to the primary-TRP, UE capability information,
receive, from the primary-TRP, a radio resource control (RRC) reconfiguration message,
transmit, to the primary-TRP, a RRC reconfiguration complete message; and
transmit data to the primary-TRP and a secondary-TRP,
wherein the UE capability information includes beam information related to whether the UE uses at least one of a phase array antenna (PAA) and multi-beams, and
wherein at least one resource of the primary-TRP and the secondary-TRP is allocated based on the beam information.

16-18. (canceled)
